(19) United States
(12) Patent Application Publication
(10) Pub. No.: US 2022/0194676 A1
(43) Pub. Date: Jun. 23, 2022

(54) LAMINATE FOR BLISTER CONTAINERS

(71) Applicant: KYODO PRINTING CO., LTD., Tokyo (JP)

(72) Inventors: Makoto KATO, Tokyo (JP); Naomi SEKIYA, Tokyo (JP); Atsushi YASUDA, Tokyo (JP)

(73) Assignee: KYODO PRINTING CO., LTD., Tokyo (JP)

(21) Appl. No.: 17/602,615

(22) PCT Filed: Apr. 9, 2020
(86) PCT No.: PCT/JP2020/016038

§ 371 Date: Oct. 8, 2021

(30) Foreign Application Priority Data
Apr. 18, 2019 (JP) 2019-079506

(51) Int. Cl. B65D 75/36; B65D 65/40; B32B 27/30; B32B 27/18; B32B 27/32; B65D 81/26

(52) U.S. Cl. CPC B65D 75/36; B32B 2264/1023; B32B 27/306; B32B 27/18; B32B 27/304; B32B 27/32; B65D 81/267; B32B 2439/80; B32B 2307/724; B32B 2307/412; B32B 2264/301; B32B 2264/302; B32B 2307/308; B32B 2307/728; B32B 2264/1021; B65D 65/40

(57) ABSTRACT

A laminate for blister containers according to the present invention is provided with a transparent base material layer and a transparent moisture absorption layer, wherein the transparent moisture absorption layer contains zeolite having an average particle diameter D50 of 100 nm or less, an ester compound having an HLB value of 5 or less and a thermoplastic resin, and the melt flow rate of a resin composition constituting the transparent moisture absorption layer 102 is 0.3 to 30 g/10 min inclusive as measured in accordance with JIS K7210 under the conditions including a temperature of 190° C. and a load of 21.18 N.

### FIELD

The present invention relates to a laminate for a blister container.

### BACKGROUND

Conventionally, blister packs have been used as packaging containers for solid formulations such as tablets and capsules accommodating medicines. The blister pack can be formed by forming a recess called a pocket in a sheet for a blister container composed of a resin sheet or the like to form a blister container, putting the contents in the pocket, and bonding a lid member (cover member) by heat sealing or the like.

In a state where a formulation or the like is accommodated inside the pocket of the blister container, a cover member is heat-sealed to a skirt portion extending around the pocket to afford a contents-containing blister pack in which the formulation or the like is enclosed.

The active ingredient of the formulation enclosed in the blister pack includes various ingredients. Among these, some active ingredients have low moisture resistance and some active ingredients have strong odor. Therefore, there has been proposed a technique of previously providing an absorbing layer, which absorbs moisture, odor or the like, with a sheet for a blister container or a cover material, thereby providing an absorptive function to a blister pack after molding.

PTL 1 discloses a film for a PTP or blister pack in which a moisture absorbing layer containing a desiccant and a barrier layer as the outermost layer are laminated. The moisture absorbing layer contains at least one desiccant selected from the group consisting of a physically adsorbing desiccant and a chemically adsorbing desiccant in an amount of 5% by weight or more and 70% by weight or less based on the weight of the moisture absorbing layer, and contains a pigment in a total pigment amount of 40% by weight or more and 70% by weight or less.

PTL 2 discloses a moisture absorbing material including a moisture absorbing layer having a porous structure and a moisture-resistant layer in this order. The moisture absorbing layer contains an amorphous silica, a water-soluble resin, and at least one moisture absorbing agent selected from silica gel, zeolite, a water absorbing polymer and a hygroscopic salt, and at least one selected from a plasticizer as a glycol-based compound and a resin having a glass transition temperature of 50° C. or lower. A ratio of the content of the plasticizer and the resin having a glass transition temperature of 50° C. or lower to the content of the amorphous silica being 5 mass % or more and 20 mass % or less.

PTL 3 discloses a film which has extremely high transparency and is useful as a film for sealing an organic EL or the like.

PTLs 4 and 5 mention methods for producing a zeolite having a nano-particle size.

### CITATION LIST

### Patent Literature

[PTL 1] JP 2006-327690 A
[PTL 2] JP 6211686 B1
[PTL 3] JP 2018-100390 A
[PTL 4] JP 2011-246292 A
[PTL 5] JP 201349602 A

### SUMMARY

### Technical Problem

In recent years, a blister pack is sometimes required to have sufficient transparency to see contents such as tablets attached with visible information such as expiration dates without opening the blister pack. However, when a moisture absorbing layer is provided, as in PTL 1, the transparency may not be achieved.

Although PTL 2 mentions the transparency, there is room for further improvement in view of achievement of both transparency and hygroscopicity, as well as ease of production.

Therefore, there is a need to provide a novel laminate for a blister container, which has the hygroscopicity and improved transparency, and can be easily produced and molded.

### Solution to Problem

The present inventors have intensively studied and found that the above problems can be solved by the following means, thus completing the present invention. That is, the present invention is as follows.

### <Aspect 1>

A laminate for a blister container, comprising a transparent substrate layer and a transparent moisture absorbing layer, wherein

the transparent moisture absorbing layer contains a zeolite having an average particle size D50 of 300 nm or less, an ester compound having an HLB value 5 or less, and a thermoplastic resin, and

a resin composition constituting the transparent moisture absorbing layer has a melt flow rate of 0.3 g/10 min or more and 30 g/10 min or less, as measured under the conditions of a temperature of 190° C. and a load of 21.18 N in conformity with JIS K7210.

### <Aspect 2>

The laminate for a blister container according to Aspect 1, wherein the average particle size D50 of the zeolite is 100 nm or less.

### <Aspect 3>

The laminate for a blister container according to Aspect 1 or 2, wherein the zeolite is hydrophilic.

### <Aspect 4>

The laminate for a blister container according to any one of Aspects 1 to 3, wherein the ester compound is a monoester of an alkylene glycol having 2 or more and 6 or less carbon atoms and a fatty acid having 15 or more and 24 or less carbon atoms.

### <Aspect 5>

The laminate for a blister container according to any one of Aspects 1 to 4, wherein the haze in conformity with JIS K 7136 is 25% or less.

### <Aspect 6>

The laminate for a blister container according to any one of Aspects 1 to 5, wherein the total light transmittance in conformity with JIS K 7361 is 50% or more.

### <Aspect 7>

The laminate for a blister container according to any one of Aspects 1 to 6, wherein the thermoplastic resin is a polyolefin-based resin.

### <Aspect 8>

The laminate for a blister container according to Aspect 7, wherein the polyolefin-based resin is an ethylene-vinyl acetate copolymer.

### <Aspect 9>

The laminate for a blister container according to any one of Aspects 1 to 8, wherein the transparent substrate layer is a transparent barrier substrate layer.

### <Aspect 10>

The laminate for a blister container according to Aspect 9, wherein the transparent barrier substrate layer includes a substrate resin layer and a transparent barrier layer.

### <Aspect 11>

The laminate for a blister container according to any one of Aspects 1 to 10, wherein the substrate resin layer is composed of at least one selected from the group consisting of polyvinyl chloride and a polypropylene-based resin.

### <Aspect 12>

A contents-containing blister package comprising:

contents,

a blister container which is composed of the laminate for a blister container according to any one of Aspects 1 to 11 and has a pocket, and

a lid member adhered to the blister container, thereby enclosing the contents.

### Advantageous Effects of Invention

According to the present invention, it is possible to provide a laminate for a blister container, which has the hygroscopicity and improved transparency, and can be easily produced and molded.

### BRIEF DESCRIPTION OF DRAWINGS

FIG. 1 is a side sectional view showing a layer structure of a laminate for a blister container of the present invention.

FIG. 2 is a side sectional view showing a layer structure of a contents-containing blister pack of the present invention.

### DESCRIPTION OF EMBODIMENTS

### <<Laminate for Blister Container>>

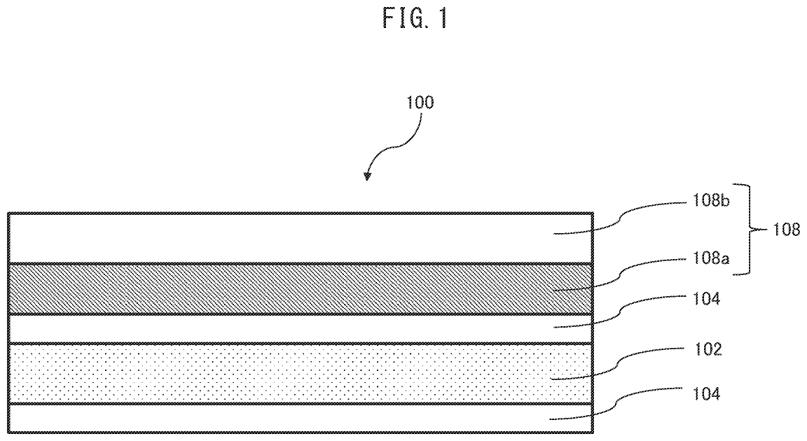

As shown in FIG. 1, the laminate for a blister container 100 of the present invention comprises:

a transparent substrate layer 108 and a transparent moisture absorbing layer 102,

the transparent moisture absorbing layer contains a zeolite having an average particle size D50 of 300 nm or less, an ester compound having an HLB value 5 or less, and a thermoplastic resin, and

a resin composition constituting the transparent moisture absorbing layer 102 has a melt flow rate of 0.3 g/10 min or more and 30 g/10 min or less, as measured under the conditions of a temperature of 190° C. and a load of 21.18 N in conformity with JIS K7210.

The laminate for a blister container 100 may also comprise a transparent skin layer 104 on one or both sides of the transparent moisture absorbing layer 102.

In the present invention, the term “transparent” means that it is sufficiently transparent to visually recognize characters of the contents and, for example, the total light transmittance is 50% or more, 60% or more, 70% or more, 75% or more. 80% or more, 85% or more, 90% or more, 95% or more, or 100%, and the haze value is 50% or less, 45% or less, 40% or less, 35% or less, 30% or less, 25% or less, 20% or less, 15% or less, or 10% or less.

The total light transmittance can be measured in conformity with JIS K 7361, and the haze value can be measured in conformity with JIS K 7136.

With the above configuration, it is possible to provide a laminate for a blister package, which has the hygroscopicity and improved transparency, and can be easily produced and molded.

Hereinafter, each constituent element of the present invention will be described.

### <Transparent Substrate Layer>

The transparent substrate layer is a substrate having the transparency. The transparent substrate layer is preferably a transparent barrier substrate layer further having barrier properties, from the viewpoint of suppressing moisture absorption from the outside.

It is possible to use, as the transparent barrier substrate layer, for example, a barrier resin layer. It is possible to use, as the resin constituting the barrier resin layer, for example, a cyclic olefin polymer, an ethylene-vinyl alcohol copolymer, polychlorotrifluoroethylene (PCTFE) or the like.

As shown in FIG. 1, the transparent barrier substrate layer 108 may also be a layer including a transparent barrier layer 108a and a transparent substrate resin layer 108b. In this case, an adhesive layer may be present between the transparent barrier layer and the transparent substrate resin layer.

### (Transparent Barrier Layer)

It is possible to use, as the transparent barrier layer, a material capable of suppressing permeation of moisture, an organic gas, and an inorganic gas from the outside into the transparent moisture absorbing layer. It is possible to use, as the transparent barrier layer, for example, an inorganic vapor-deposited film such as a silica vapor-deposited film, an alumina vapor-deposited film or a silica-alumina binary vapor-deposited film, or an organic coating film such as a polyvinylidene chloride coating film, a polychlorotrifluoroethylene coating film or a polyvinylidene fluoride coating film. The barrier resin layer can also be used as the transparent barrier layer.

When an inorganic substance vapor-deposited film or an organic substance coating film is used as the transparent barrier layer, the thickness of the transparent barrier layer is preferably 100 nm or more, 200 nm or more, 300 nm or more, 500 nm or more, 700 nm or more, or 1 μm or more, from the viewpoint of securing the strength and barrier properties, and preferably 5 μm or less, 4 μm or less, 3 μm or less, or 2 μm or less, from the viewpoint of improving the handleability as a cover material.

When a barrier resin layer or an organic substance coating film is used as the transparent barrier layer, the thickness of the transparent barrier layer is preferably 7 μm or more, 10 μm or more, or 15 μm or more, from the viewpoint of securing the strength and barrier properties, and preferably 100 μm or less, 80 μm or less, 60 μm or less, 55 μm or less, 50 μm or less, 45 μm or less, 40 μm or less, or 35 μm or less, from the viewpoint of improving the handleability as a cover material.

### (Transparent Substrate Resin Layer)

It is possible to use, as the transparent substrate resin layer, thermoplastic resins having excellent impact resistance, abrasion resistance or the like, for example, thermoplastic resins such as a polyolefin-based resin, a vinyl-based polymer, polyester and a polyamide alone, or two or more thereof can be used in combination in multiple layers. This resin layer may be either a stretched film or a non-stretched film. This resin layer may also be present on one or both sides of the transparent barrier layer. This resin layer can protect the transparent barrier layer.

Examples of the polyolefin-based resin include a polyethylene-based resin, a polypropylene-based resin and the like.

As used herein, the term “polyethylene-based resin is a resin including more than 50 mol %, 60 mol % or more, 70 mol % or more, or 80 mol % or more, of a repeating unit of an ethylene group in the main chain of the polymer and, for example, is selected from the group consisting of low-density polyethylene (LDPE), linear low-density polyethylene (LLDPE), medium-density polyethylene (MDPE), high-density polyethylene (HDPE), ethylene-acrylic acid copolymer (EAA), ethylene-methacrylic acid copolymer (EMAA), ethylene-ethyl acrylate copolymer (EEA), ethylene-methyl acrylate copolymer (EMA), derivatives thereof, and mixtures thereof.

As used herein, the term “polypropylene-based resin” is a resin including more than 50 mol %, 60 mol % or more, 70 mol % or more, or 80 mol % or more, of a repeating unit of a propylene group in the main chain of the polymer and includes, for example, polypropylene (PP) homopolymer, random polypropylene (random PP), block polypropylene (block PP), chlorinated polypropylene, acid-modified polypropylene, derivatives thereof, and mixtures thereof.

The vinyl-based polymer includes, for example, polyvinyl chloride (PVC) or the like.

The polyester includes, for example, polyethylene terephthalate (PET), polybutylene terephthalate or the like.

The polyamide includes, for example, nylon such as nylon (registered trademark) 6 or nylon MXD6.

It is preferable to use, as the material of the transparent substrate resin layer, polyvinyl chloride and/or polypropylene-based resin, from the viewpoint of achieving both moldability and rigidity.

The thickness of the transparent substrate resin layer is preferably 10 μm or more, 20 μm or more, 30 μm or more, 50 μm or more, 70 μm or more, 100 μm or more, 120 μm or more, 150 μm or more, 180 μm or more, or 200 μm or more, from the viewpoint of satisfactorily protecting a barrier layer, and preferably 300 μm or less, 280 μm or less, 250 μm or less, or 220 μm or less, from the viewpoint of improving the handleability as a blister container.

### <Transparent Moisture Absorbing Layer>

It is a layer containing a zeolite having an average particle size D50 of 300 nm or less, an ester compound having an HLB value of 5 or less, and a thermoplastic resin.

The melt flow rate of the resin composition constituting the transparent moisture absorbing layer is 0.3 g/10 min or more and 30 g/10 min or less, as measured under the conditions of a temperature of 190° C. and a load of 21.18 N in conformity with JIS K7210. This makes it relatively easy to form a film by the T-die method or the inflation method, which makes it possible to facilitate the production of a transparent cover material. This melt flow rate may be 0.5 g/10 min or more, 1.0 g/10 min or more, 3.0 g/10 min or more, or 5.0 g/10 min or more, or may be 20 g/10 min or less, or 15 g/10 min or less, 10 g/10 min or less, 8.0 g/10 min or less, or 5.0 g/10 min or less. For example, this melt flow rate may be 0.5 g/10 min or more and 10 g/10 min or less.

The haze of the resin composition constituting the transparent moisture absorbing layer is preferably 25% or less, or may be 20% or less, or 15% or less, as measured on a film having a thickness of 100 μm before moisture absorption in conformity with JIS K7136. The haze may be, for example, 3% or more and 25% or less, or 5% or more and 20% or less. If the haze is within such a range, it is possible to provide a film with the transparency to the extent that the inside can be clearly confirmed when it is used as a packaging container or the like. As used herein, the term “film before moisture absorption” means a film immediately after melting the resin composition and forming a film thereof.

The transparent moisture absorbing layer may or may not contain an oxide (excluding zeolite) of one or more elements selected from Al, Si, Ti, and Zr, each having an average particle size D50 of 100 nm or less. The content of such an oxide may be, for example, 5 mass % or less, 3 mass % or less, 1 mass % or less, or 0 mass %.

### (Zeolite)

The zeolite contained in the transparent moisture absorbing layer is a zeolite particle having an average particle size D50 of 300 nm or less. The pore (absorption port) diameter of the zeolite may be 0.3 nm or more and 1 nm or less, or may be 0.3 nm or more and 0.5 nm or less.

The average particle size D50 of the zeolite means the particle size at a cumulative value of 50% in the particle size distribution based on the number of particles by measuring the major axis of 100 randomly selected particles using a scanning electron microscope (SEM). The average particle size D50 of the zeolite is 300 nm or less, and more preferably 100 nm or less, from the viewpoint of imparting the transparency to the composition. The average particle size D50 of the zeolite may be 300 nm or less, 250 nm or less, 200 nm or less, 150 nm or less, 130 nm or less, 100 nm or less, 80 nm or less, 70 nm or less, 60 nm or less, or 50 nm or less. The average particle size D50 of the zeolite may be 5 nm or more, 10 nm or more, 20 nm or more, or 30 nm or more. For example, the average particle size D50 of zeolite may be 5 nm or more and 100 nm or less, or 20 nm or more and 80 nm or less.

The value of an atomic ratio of Si to Al (Si/Al) in the zeolite is arbitrary, and may be, for example, 1 or more, 2 or more, 3 or more, 5 or more, 10 or more, or 15 or more, for example, it may be 80 or less, 60 or less, 50 or less, 40 or less, or 30 or less.

The zeolite used in the present invention is preferably hydrophilic from the viewpoint of the hygroscopicity, and particularly preferably a Na-A type zeolite.

The zeolite used in the present invention can be produced, for example, by the method as mentioned in PTLs 4 and 5. Such zeolite may be used after adjusting the bulk density as mentioned in PTL 3.

The zeolite can be obtained, for example, by dispersing a raw zeolite represented by the following formula (1) in an aqueous solution containing a silicate or aluminosilicate represented by the following formula (2), followed by recrystallization:

aM¹₂O.bSiO₂.Al₂O₃.cMeO (1)

wherein, in formula (1), M¹ is an alkali metal atom, a hydrogen atom, or an ammonium ion, Me is an alkali earth metal ion atom, a is 0.01 to 1, b is 1 to 80, and c is 0 to 1:

dM²₂O.eAl₂O3.fSiO₂.gH₂O (2)

wherein, in formula (2), a ratio d/g is 0.00035 to 0.02000, a ratio e/g is 0 to 0.00025, and f/g is 0.0001 to 0.025.

b in formula (1) may be, for example, 2 to 60 or 20 to 80. c may be, for example, 0.01 to 1. The ratio d/g in formula (2) may be, for example, 0.003 to 0.010. The ratio e/g may be, for example, 0 or 0.000003 to 0.000250. The ratio f/g may be, for example, 0.0001 to 0.0160 or 0.006 to 0.025.

It is possible to use, as the raw zeolite of formula (1), for example, NaSiAlO₄, NaSi₁₂AlO₂₆, NH₄Si₁₉AlO₄₀ or the like. It is possible to use, as the silicate of formula (2), for example, 0.292Na₂O.hSiO₂.55.5H₂O (h=0.400, 0.650, 0.800, or 1.00), iNa₂O.0.650SiO₂.55.5H₂O (i=0.165 or 0.55) or the like. It is possible to use, as the aluminosilicate of formula (2), for example, 405Na₂O.jAl₂O₃.kSiO₂.29,900H₂O ((j,k)=(1,23), (1,51), (2,23), or (2,51)) or the like.

As the zeolite, the zeolite obtained as mentioned above may be used after subjecting to either or both of ion exchange and pulverization.

The content of the zeolite in the transparent moisture absorbing layer is 3.0 mass % or more and 45 mass % or less, or may be 5 mass % or more, 10 mass % or more, 20 mass % or more, 30 mass % or more, 35 mass % or more, or 40 mass % or more, or may be 40 mass % or less, or 35 mass % or less. The content of zeolite may be, for example, 10 mass % or more and 45 mass % or less, or 30 mass % or more and 45 mass % or less.

### (Ester Compound)

The transparent moisture absorbing layer contains an ester compound having an HLB value of 5 or less. It is possible to use, as the ester compound, a compound which can be used as an emulsifier or the like, which makes it possible to mix the zeolite used in the present invention with a thermoplastic resin.

The HLB value is an index which indicates whether the ester compound has hydrophilicity or lipophilicity. The fact that the HLB value of the ester compound is 5 or less means that the ester compound has high lipophilicity, and is, for example, a numerical value of a region used as a defoamer or an emulsifier of an emulsion.

The HLB value of the ester compound may be 4.5 or less, 4.0 or less, or 3.5 or less, or may be 2.0 or more, 2.5 or more, or 3.0 or more. The HLB value of the ester compound may be, for example, 2.0 or more 5.0 or less, or 2.5 or more 4.5 or less.

The ester compound is, for example, a monoester compound of a polyhydric alcohol and a fatty acid. The polyhydric alcohol may be, for example, glycerin, alkylene glycol or the like. The fatty acid may be, for example, a saturated or unsaturated fatty acid having 12 or more and 24 or less carbon atoms.

The ester compound may be, particularly, a monoester of an alkylene glycol having 2 or more and 6 or less carbon atoms and a fatty acid having 15 or more and 24 or less carbon atoms. The alkylene glycol may be, for example, ethylene glycol, propylene glycol, diethylene glycol or the like. The alkylene glycol and the fatty acid having 15 or more and 24 or less carbon atoms may be saturated or unsaturated, and may be, for example, stearic acid, behenic acid or the like.

Specifically, the ester compound may be, for example, propylene glycol monostearate, propylene glycol monobehenate or the like.

The content of the ester compound in the transparent moisture absorbing layer is 2.0 mass % or more and 15 mass % or less, or may be 2.5 mass % or more, 3.0 mass % or more, or 5.0 mass % or more, or may be 12 mass % or less, 10 mass % or less, 8.0 mass % or less, or 6.0 mass % or less. The content of the ester compound may be, for example, 2.5 mass % or more and 12 mass % or less, or 3.0 mass % or more and 10 mass % or less.

### (Thermoplastic Resin)

The transparent moisture absorbing layer contains a thermoplastic resin, particularly a thermoplastic resin including an ethylene unit. Particularly, the transparent moisture absorbing layer is preferably a thermoplastic resin having a polar group such as a carboxylic acid group or a carboxylic acid ester group, and including an ethylene unit.

From the viewpoint of the affinity with the zeolite and the ester compound, it is possible to particularly exemplify an ethylene-vinyl acetate copolymer among the thermoplastic resin. The content of vinyl acetate in the ethylene-vinyl acetate copolymer may be 10 mass % or more, 15 mass % or more, 20 mass % or more. 25 mass % or more, or 30 mass % or more, or may be 60 mass % or less, 55 mass % or less, 50 mass % or less, 45 mass % or less, or 40 mass % or less. The content of vinyl acetate in the ethylene-vinyl acetate copolymer may be, for example, 5 mass % or more 50 mass % or less, or 20 mass % or more 40 mass % or less.

The content of the thermoplastic resin in the transparent moisture absorbing layer may be 40 mass % or more, 50 mass % or more, 60 mass % or more, or 70 mass % or more, or may be 80 mass % or less, 70 mass % or less, 60 mass % or less, or 50 mass % or less. The content of the thermoplastic resin may be, for example, 40 mass % or more and 80 mass % or less, or 50 mass % or more and 70 mass % or less.

### (Other Components)

The transparent moisture absorbing layer can further contain, in addition to the above components, optional additives such as lubricants, antistatic agents, mold release agents, plasticizers, antioxidants, antibacterial agents, antifungal agents, and ultraviolet absorbers, as necessary.

### <Transparent Skin Layer>

The transparent skin layer is a layer which contains a resin for a transparent skin layer and can be present on one or both sides of the transparent moisture absorbing layer. The transparent skin layer may be present on the side opposite the transparent base layer side of the transparent moisture absorbing layer, and may be further present on the transparent substrate layer side of the transparent moisture absorbing layer. The transparent skin layer may also be fused to the transparent moisture absorbing layer.

In particular, the transparent skin layer can prevent the zeolite contained in the transparent moisture absorbing layer from falling off and coming into contact with the contents. Further, in this case, the transparent skin layer may be a layer containing no absorbent. The transparent skin layer may be, for example, a layer containing no absorbent. Examples of the absorbent include physical absorbents such as zeolite and silica gel, and chemical absorbents such as calcium oxide, magnesium sulfate, calcium chloride, calcium oxide, and aluminum oxide.

The thickness of the transparent skin layer can be 1 μm or more, 3 μm or more, 5 μm or more, or 7 μm or more, and can be 50 μm or less, 40 μm or less, 30 μm or less, 20 μm or less, or 15 μm or less. When a plurality of transparent skin layers are present, the thickness of each transparent skin layer may be the same or different.

### (Resin for Transparent Skin Layer)

It is possible to use, as the resin for a transparent skin layer, the thermoplastic resins mentioned for the transparent substrate resin layer alone or in combination, and among these, a polyolefin-based resin, particularly a polyethylene-based resin, is preferably used from the viewpoint of the workability or the like. When the skin layer is present on both sides of the transparent moisture absorbing layer, the transparent skin layer resin constituting the transparent skin layers may be the same or different.

### <Other Layers>

The laminate for a blister container may include other optional layers. Examples of the other layer include an adhesive layer existing between the layers.

### <<Blister Package>>

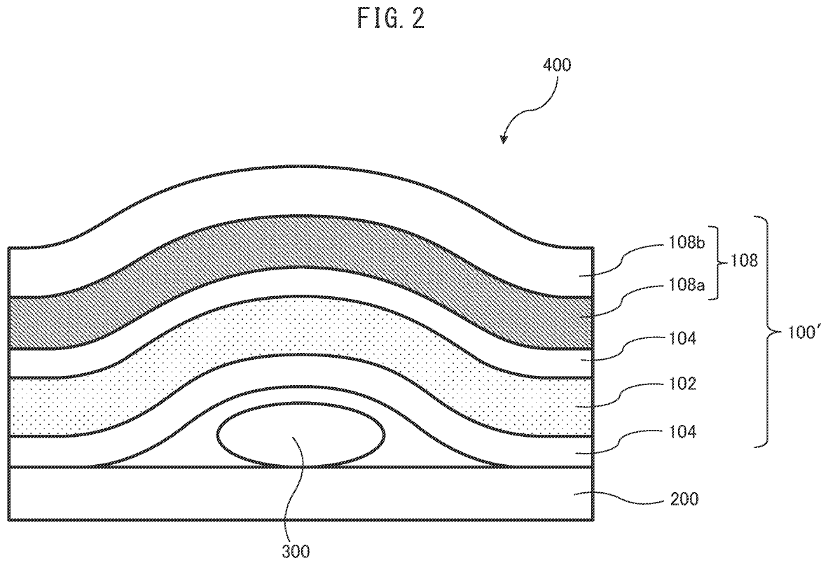

As shown in FIG. 2, a blister package of the present invention includes:

contents 300,

a blister container 100′ which is composed of the laminate for a blister container and has a pocket, and

a lid member 200 adhered to the blister container 100′, thereby enclosing the contents 300.

The lid member 200 may be adhered to the blister container 100′ via an adhesive layer, or may be fused to the blister container 100′.

### <Contents>

The contents are contents sealed in the pocket of the blister container. Such contents are not limited as long as they can be degraded by contact with the outside air, and examples thereof include, in addition to medicines, foods, cosmetics, hygiene products, medical equipment, medical appliances, electronic components and the like. Further, the medicines include, in addition to pharmaceutical formulations, cleaners, pesticides, reagents and the like.

In particular, when the contents are contents which are preferably visually recognizable, for example, pharmaceutical preparations attached with character information such as expiration dates, the configuration of the present invention becomes more useful.

### <Blister Container>

The blister container is composed of the laminate for a blister container and has a pocket.

Such blister container can be produced, for example, by forming a pocket for accommodating the contents, in the laminate for a blister container. Examples of the method for molding the pocket include a flat-plate type air-pressure molding method, a plug assist compressed-air molding method, a drum-type vacuum molding method, a plug molding method and the like. Among these, the plug molding method using a round-tip cylindrical rod (plug material) made of an ultra-high-molecular-weight polyethylene resin having a viscosity-average molecular weight of 1,000,000 or more is preferable for forming the pocket.

### <Cover Material>

The lid member is adhered to the blister container, thereby sealing the contents. The lid member may include, for example, a substrate resin layer and a barrier layer. The lid member may also include an easily peelable layer on the surface to be adhered to the blister container. The lid member may or may not be transparent as a whole.

It is possible to use, as the cover material, for example, a commercially available lid member for a press-though packages (PTP).

### EXAMPLES

The present invention will be specifically described by way of Examples and Comparative Examples, but the present invention is not limited thereto.

### <<Fabrication of Laminate for Blister Container>>

Using a multi-layer film forming machine, a two-kind three-layer transparent moisture absorbing film was fabricated such that a transparent skin layer, a transparent moisture absorbing layer A, and a transparent skin layer are arranged in this order. As the transparent skin layer, linear low-density polyethylene was used. The transparent moisture absorbing layer A was formed using a resin composition fabricated by melt-kneading 48 mass parts of an ethylene-vinyl acetate copolymer (EV150, Du Pont-Mitsui Polychemicals Co. Ltd.). 32 mass parts of a Na-A type zeolite (average particle size D50: 50 nm), and 5 mass parts of an ester compound (HLB value: 3.0) at a temperature of 160° C. for 10 minutes using a Banbury mixer. The thickness of each layer was 10 μm for the transparent skin layer, 40 μm for the transparent moisture absorbing layer A, and 10 μm for the transparent skin layer.

Next, a transparent silica vapor-deposited PET film (GX film. TOPPAN PRINTING CO., LTD., thickness: 12 μm) as a transparent barrier layer was laminated on one skin layer side of the transparent moisture absorbing film using a dry laminate adhesive, and a PVC substrate for PTP (Mitsubishi Chemical Corporation, thickness: 200 μm) as a transparent substrate resin layer was then laminated on the vacant side of the transparent barrier layer using a dry laminate adhesive to fabricate a laminate used for a blister container of Example 1.

### Examples 2 to 6, Comparative Examples 1 to 3 and Reference Examples 1 to 4

In the same manner in Example 1, except that the structure of each layer was changed as shown in Table 1, laminates for a blister container of Examples 2 to 6, Comparative Examples 1 to 3 and Reference Examples 1 to 4 were fabricated.

The materials mentioned in Table 1 are as follows.

CPP: CPP substrate for PTP (Mitsubishi Chemical Corporation, thickness: 200 μm)

GX film: Transparent silica vapor-deposited PET film (GX film, TOPPAN PRINTING CO., LTD., thickness: 12 μm)

PVDC: PVDC coating (thickness: 55 μm)

PCTFE: PCTFE film (thickness: 51 μm)

LLDPE: Film having a thickness of 50 μm formed of the linear low-density polyethylene

In Table 1, the term “opaque moisture absorbing layer” refers to a layer formed using a resin composition fabricated by melt-kneading 40 mass parts of the ethylene-vinyl acetate copolymer, 40 mass parts of a hydrophilic zeolite (Molecular Sieve 3A, UNION SHOWA K.K.), and 5 mass parts of the ester compound, which is used in place of the transparent moisture absorbing layer A of Example 1.

In Table 1, the term “transparent moisture absorbing layer B” refers to a layer formed in the same manner as in transparent moisture absorbing layer A, except that mass parts of the ethylene-vinyl acetate copolymer and the Na-A type zeolite were changed to 40 mass parts and 40 mass parts, respectively.

In Table 1, the term “MFR” refers to a melt flow rate (MFR) as measured under the conditions of a temperature of 190° C. and a load of 21.18 N in conformity with JIS K7210, using a melt indexer (Technol Seven Co., Ltd.) for the resin composition constituting each moisture absorbing layer.

### <<Evaluation>>

### <Moldability>

Each laminate for a blister container thus fabricated was heated on a hot plate at 100° C. or 140° C. for 1 minute, and then a pocket portion having a diameter of 13 mmφ and a depth of 5.25 mm was formed by a press machine to fabricate a blister container. The evaluation criteria are as follows.

Good: Appearance abnormalities such as cracks or cloudiness were not observed in the pocket after molding.

Poor: Appearance abnormalities such as cracks and cloudiness were observed in the pocket after molding, or a laminate for a blister container was broken during molding.

### <Haze>

Each laminate for a blister container thus fabricated was cut into size of 50 mm×50 mm, and the haze value was measured in conformity with JIS K7136, using a measuring instrument (HR-100, MURAKAMI COLOR RESEARCH LABORATORY).

### <Total Light Transmittance>

Each laminate for a blister container thus fabricated was cut into size of 50 mm×50 mm, and the total light transmittance was measured in conformity with JIS K7361, using a measuring instrument (HR-100, MURAKAMI COLOR RESEARCH LABORATORY).

### <Hygroscopicity>

Each laminate for a blister container thus fabricated was cut into size of 100 mm×100 mm, and the mass was measured. This was then stored for 24 hours in an environment at a temperature of 23° C. and a relative humidity of 50% RH. Next, the mass of the thus sored blister container laminate was measured and a difference in mass before and after storage was calculated, and then the mass value thus obtained was converted into the mass per 1 m².

The evaluation criteria are as follows.

Good: The amount of moisture absorbed is 0.5 g/m² or more.

Poor: The amount of moisture absorbed is less than 0.5 g/m².

### <Moisture Absorbing Rate (Barrier Properties)>

Each laminate for a blister container thus fabricated and the laminate composed of PET//AL//LDPE were respectively cut into size of 50 mm×50 mm and then opposed to each other, followed by heat sealing of four sides with a width of 15 mm to fabricate a 4-way seal bag, and the mass was measured. This 4-way seal bag was stored in an environment at a temperature of 23° C. and a relative humidity of 50% RH for 30 days. Next, the mass of the 4-way seal bag thus stored was measured and a difference in mass before and after storage was calculated, and then the moisture absorption rate was calculated from this difference in mass.

Table 1 shows the configurations and evaluation results of Examples and Comparative Examples.

TABLE 1

| | Structure | | | | Evaluation results | | | | |
|---|---|---|---|---|---|---|---|---|---|
| | Substrate | | Moisture absorbing layer | | | | Total light | | Barrier |
| | resin | Barrier | | MFR | | Haze | transmittance | | properties |
| | layer | layer | Type | (g/10 min) | Moldability | (%) | (%) | Hygroscopicity | (g/m² · day) |
| Example 1 | PVC | PVDC | Transparent moisture | 2.7 | Good | 10.7 | 87.1 | Good | 0.0286 |
| | | | absorbing layer A | | | | | | |
| Example 2 | PVC | GX film | Transparent moisture | 2.7 | Good | 22.6 | 86.1 | Good | 0.0274 |
| | | | absorbing layer | | | | | | |
| Example 3 | PVC | PCTFE | Transparent moisture | 2.7 | Good | 17.2 | 87.7 | Good | 0.0172 |
| | | | absorbing layer A | | | | | | |
| Example 4 | CPP | GX film | Transparent moisture | 2.7 | Good | 18.4 | 89.0 | Good | 0.0197 |
| | | | absorbing layer A | | | | | | |
| Example 5 | PVC | — | Transparent moisture | 2.7 | Good | 17.9 | 88.7 | Good | 0.3067 |
| | | | absorbing layer A | | | | | | |
| Example 6 | CPP | — | Transparent moisture | 2.7 | Good | 15.5 | 90.9 | Good | 0.0931 |
| | | | absorbing layer A | | | | | | |
| Comparative | PVC | PVDC | Opaque moisture | 16.1 | Good | 99.2 | 73.7 | Good | 0.0281 |
| Example 1 | | | absorbing layer | | | | | | |
| Comparative | PVC | PVDC | (LLDPE) | | Good | 10.6 | 86.5 | Poor | — |
| Example 2 | | | | | | | | | |
| Comparative | PVC | PVDC | Transparent moisture | 0.0 | Poor | unevaluated | unevaluated | (Good) | unevaluated |
| Example 3 | | | absorbing layer B | | | | | | |
| Reference | PVC | — | — | — | Good | 20.2 | 88.9 | Poor | — |
| Example 1 | | | | | | | | | |
| Reference | CPP | — | — | — | Good | 22.9 | 91.4 | Poor | — |
| Example 2 | | | | | | | | | |
| Reference | PVC | PVDC | — | — | Good | 9.3 | 86.9 | Poor | — |
| Example 3 | | | | | | | | | |
| Reference | PVC | PCTFE | — | — | Good | 13.2 | 89.4 | Poor | — |
| Example 4 | | | | | | | | | |

From Table 1, it will be understood that all the laminates for a blister container of Examples 1 to 6, each including a transparent moisture absorbing layer A composed of a resin composition having a melt mass flow rate of 0.3 g/10 min or more, have good moldability, transparency, and hygroscopicity.

Meanwhile, it will be understood that the laminate for a blister container of Comparative Example 1, which includes an opaque moisture absorbing layer, has poor transparency, and the laminate for a blister container of Comparative Example 2, which includes no moisture absorbing layer, has poor hygroscopicity. Further, the laminate of Comparative Example 3, which includes a transparent moisture absorbing layer B composed of a resin composition having a melt mass flow rate of less than 0.3 g/10 min, could not be formed into a blister container.

In the following, examples of the transparent moisture absorbing layer which can be used in the present invention are illustrated with reference to Reference Examples.

### Reference Example A: Example of Transparent Moisture Absorbing Film

### Production Example

According to the formulations shown in Table 2 and Table 3, a thermoplastic resin, a Na-A type zeolite (average particle size D50: 50 nm), and an ester compound (propylene glycol monobehenate, HLB value: 3.4) were melt-kneaded at 160° C. for 10 minutes using a Banbury mixer to obtain resin compositions of each Example.

### <Evaluation>

### (Melt Flow Rate)

The resin composition of each Example was cut into measurable size. The melt flow rate (MFR) of the resin composition thus cut was measured under the conditions of a temperature of 190° C. and a load of 21.18 N in conformity with JIS K7210, using a melt indexer (Technol Seven Co., Ltd.).

### (Haze)

The resin composition was cut into a predetermined weight, and a film having a thickness of 100 m was fabricated by hot press molding. Here, pressing was performed under the conditions of a temperature of 160° C. and a pressure of 40 to 60 MPa for 2 minutes. The film thus obtained was cut into 50 mm squares, and the haze was measured in conformity with JIS K7105, using a haze measuring instrument (MURAKAMI COLOR RESEARCH LABORATORY HR-100). The haze after moisture absorption was measured by allowing the film to stand in an environment of 23° C. and 50%, and after moisture absorption until the weight change after moisture absorption became constant, the measurement was performed by the same method as mentioned above.

### <Results>

Table 2 and Table 3 show the configurations and evaluation results of Examples and Comparative Examples.

TABLE 2

| | | | | | | Physical properties of resin composition | | | |
|---|---|---|---|---|---|---|---|---|---|
| | | | | | | | Haze [%] | | |
| | Thermoplastic resin | | | | Ester | | Before | After | Amount |
| | Product | | MFR | Zeolite | compound | MFR | moisture | moisture | of |
| | name | Type | [g/10 min] | mass % | mass % | [g/10 min] | absorption | absorption | change |
| Reference | EV150 | EVA | 30 | 37 | 5.8 | 2.7 | 14.9 | 1.5 | 13.4 |
| Example A1 | | | | | | | | | |
| Reference | EV150 | EVA | 30 | 42 | 5.8 | 0.5 | 14.3 | 1.5 | 12.8 |
| Example A2 | | | | | | | | | |
| Reference | Ultracene | EVA | 60 | 37 | 5.8 | 6.5 | 24.2 | 1.5 | 22.7 |
| Example A3 | 752 | | | | | | | | |
| Reference | Ultracene | EVA | 60 | 42 | 5.8 | 0.9 | 18.7 | 1.7 | 17.0 |
| Example A4 | 752 | | | | | | | | |
| Reference | EV150 | EVA | 30 | 47 | 5.8 | 0.0 | 11.1 | 2.5 | 8.6 |
| Comparative | | | | | | | | | |
| Example A1 | | | | | | | | | |

TABLE 3

| | | | | | | Physical properties of resin composition | | | |
|---|---|---|---|---|---|---|---|---|---|
| | | | | | | | Haze [%] | | |
| | Thermoplastic resin | | | | Ester | | Before | After | Amount |
| | Product | | MFR | Zeolite | compound | MFR | moisture | moisture | of |
| | name | Type | [g/10 min] | mass % | mass % | [g/10 min] | absorption | absorption | change |
| Reference | EV150 | EVA | 30 | 37 | 8.2 | 4.4 | 19.9 | 1.8 | 18.1 |
| Example A5 | | | | | | | | | |
| Reference | EV150 | EVA | 30 | 37 | 5.8 | 2.7 | 14.9 | 1.5 | 13.4 |
| Example A1 | | | | | | | | | |
| Reference | EV150 | EVA | 30 | 37 | 3.5 | 1.0 | 23.3 | 1.3 | 22.0 |
| Example A6 | | | | | | | | | |
| Reference | EV150 | EVA | 30 | 37 | 1.2 | 0.0 | 31.6 | 1.5 | 30.1 |
| Comparative | | | | | | | | | |
| Example A2 | | | | | | | | | |

Referring to Table 2, it was found that the melt flow rate of the resin composition decreased significantly as the content of the zeolite increased. This tendency can also be confirmed in Reference Examples A3 and A4. In Reference Comparative Example A1, the melt flow rate decreased to the extent that it was impossible to mold by the T-die method or the inflation method.

Referring to Table 3, it was found that as the content of the ester compound decreased, the melt flow rate of the resin composition decreased significantly and the haze increased. In Reference Comparative Example A2, the melt flow rate decreased to the extent that it was impossible to mold by the T-die method or the inflation method, and the transparency was also degraded.

### REFERENCE SIGNS LIST

100: Laminate for a blister container
100′: Blister container
102: Transparent moisture absorbing layer
104: Transparent skin layer
108: Transparent (barrier) substrate layer
108a: Transparent barrier layer
108b: Transparent substrate resin layer
200: Cover material
300: Contents
400: Contents-containing blister package

1. A laminate for a blister container, comprising a transparent substrate layer and a transparent moisture absorbing layer, wherein
the transparent moisture absorbing layer contains a zeolite having an average particle size D50 of 300 nm or less, an ester compound having an HLB value 5 or less, and a thermoplastic resin, and
a resin composition constituting the transparent moisture absorbing layer has a melt flow rate of 0.3 g/10 min or more and 30 g/10 min or less, as measured under the conditions of a temperature of 190° C. and a load of 21.18 N in conformity with JIS K7210.

2. The laminate for a blister container as claimed in claim 1, wherein the average particle size D50 of the zeolite is 100 nm or less.

3. The laminate for a blister container as claimed in claim 1, wherein the zeolite is hydrophilic.

4. The laminate for a blister container as claimed in claim 1, wherein the ester compound is a monoester of an alkylene glycol having 2 or more and 6 or less carbon atoms and a fatty acid having 15 or more and 24 or less carbon atoms.

5. The laminate for a blister container as claimed in claim 1, wherein the haze in conformity with JIS K 7136 is 25% or less.

6. The laminate for a blister container as claimed in claim 1, wherein the total light transmittance in conformity with JIS K 7361 is 50% or more.

7. The laminate for a blister container as claimed in claim 1, wherein the thermoplastic resin is a polyolefin-based resin.

8. The laminate for a blister container as claimed in claim 7, wherein the polyolefin-based resin is an ethylene-vinyl acetate copolymer.

9. The laminate for a blister container as claimed in claim 1, wherein the transparent substrate layer is a transparent barrier substrate layer.

10. The laminate for a blister container as claimed in claim 9, wherein the transparent barrier substrate layer includes a substrate resin layer and a transparent barrier layer.

11. The laminate for a blister container as claimed in claim 1, wherein the substrate resin layer is composed of at least one selected from the group consisting of polyvinyl chloride and a polypropylene-based resin.

12. A contents-containing blister package comprising:
contents,
a blister container which is composed of the laminate for a blister container as claimed in claim 1 and has a pocket, and
a lid member adhered to the blister container, thereby enclosing the contents.
